(19) United States
(12) Patent Application Publication
(10) Pub. No.: US 2026/0210446 A1
(43) Pub. Date: Jul. 23, 2026

(54) DUAL-CHANNEL CAGE-TYPE SUBSEA THROTTLE VALVE

(71) Applicant: CHINA UNIVERSITY OF PETROLEUM-BEIJING, Beijing (CN)

(72) Inventors: Yingying WANG, Beijing (CN); Wujun TONG, Beijing (CN); Zeqing LIN, Beijing (CN); Luran TIAN, Beijing (CN); Xingye LI, Beijing (CN); Chao YANG, Beijing (CN); Baofu WANG, Beijing (CN); Rulong JIN, Beijing (CN); Yufang LI, Beijing (CN); Haibo SUN, Beijing (CN); Junjie HAN, Beijing (CN); Dingwen HUANG, Beijing (CN)

(21) Appl. No.: 19/445,200

(22) Filed: Jan. 9, 2026

(30) Foreign Application Priority Data
Jan. 22, 2025 (CN) 202510100391.2

(51) Int. Cl. F16K 5/10; F16K 5/04; F16K 31/04

(52) U.S. Cl. CPC F16K 5/10; F16K 5/0407; F16K 31/043

(57) ABSTRACT

A dual-channel cage-type subsea throttle valve includes an upper valve cover, a middle valve body, a valve body and a lower valve cover. Two upper valve chambers are provided in the middle valve body. Two lower valve chambers that are communicated with each other are provided in the valve body. A driving cam, a motor, a baffle and a spring are provided in each of the two upper valve chambers. The spring is arranged between the baffle and a bottom surface of the upper valve chamber. A valve stem, a valve core, a cage sheath, a valve core holder and a valve seat are provided in each of the two lower valve chambers. The top of the valve stem is connected to the baffle. Each of a side wall of the valve core and a side wall of the cage sheath is provided with a throttle hole.

This application claims priority to Chinese Patent Application No. 202510100391.2, filed on January 22, 2025, which is hereby incorporated by reference in its entirety.

### FIELD

The present application relates to the technical field of throttle valves, and in particular, to a dual-channel cage-type subsea throttle valve.

### BACKGROUND

Subsea throttle valves, as a critical component of subsea production systems, are used to regulate the flow and velocity of production units and control the commissioning and shutdown of oil and gas wells. Due to harsh operating environments, high operating pressures, high fluid velocities, the subsea throttle valves are prone to vibration, noise, and erosion damage.

In the process of offshore oil exploitation, a throttle valve is connected to a subsea Christmas tree to control offshore oil and gas production. The high speed of oil and gas transportation may easily lead to unstable throttling, high noise, and poor erosion resistance of the throttle valve, thus affecting the service life of the throttle valve.

In the conventional technology, throttle valves vary in structure. For an inner-cage-type throttle valve for choked flow service, high-velocity fluid in the throttle valve directly contacts a valve core of the throttle valve, and the valve core is not protected by an outer protective sleeve, resulting in insufficient erosion life of the valve core. For a cage-type throttle valve, the throttle valve has a valve stem assembly that is of a slender rod structure. The valve stem assembly is subjected to fluid pressure and forces from other components of the throttle valve when the throttle valve is in a closed state, so that the valve stem assembly is prone to bending and torsion deformation, which may easily lead to failure of the valve stem assembly.

### SUMMARY

To address at least one of the above issues in the conventional technology, the present application aims to provide a dual-channel cage-type subsea throttle valve, where two channels are provided in a valve body of the throttle valve, which can reduce the oil-gas velocity and decrease the impact of high-speed fluid on a wall surface of a valve core, thereby reducing vibration and noise caused by the impact and improving the service life of the throttle valve.

In order to achieve the above object, the present application adopts the following technical solutions.

A dual-channel cage-type subsea throttle valve includes:

an upper valve cover;

a middle valve body, where two upper valve chambers are defined in the middle valve body, and the upper valve cover is connected to a top of the middle valve body;

a valve body connected to a bottom of the middle valve body, where lower valve chambers are defined in the valve body, and the two upper valve chambers are respectively connected to the lower valve chambers, the valve body is provided with a fluid inlet connected to the lower valve chambers; and

a lower valve cover connected to a bottom of the valve body, where the lower valve cover is provided with a fluid outlet, and the two lower valve chambers are connected to the fluid outlet;

a driving cam, a motor, a baffle, and a spring are provided in each of the two upper valve chambers, where the motor is connected to the driving cam, the baffle is arranged below the driving cam, and the spring is arranged between the baffle and a bottom surface of the upper valve chamber;

a valve stem, a valve core, a cage sheath, a valve core holder and a valve seat are provided in each of the two lower valve chambers;

the valve stem is slidably arranged in the lower valve chamber and has a top that extends into the upper valve chamber and is sleeved in the spring, and the top of the valve stem is connected to the baffle;

the valve core is arranged in an upper part of the lower valve chamber and sleeved outside the valve stem;

the cage sheath is sleeved outside the valve core, a side wall of the valve core and a side wall of the cage sheath are respectively provided with throttling holes;

the valve core holder is arranged below the valve core to fix and support the valve core; and

the valve seat is arranged below the cage sheath and sleeved outside the valve core holder.

In an embodiment, a sealing gasket ring is mounted between the upper valve cover and the middle valve body.

In an embodiment, the upper valve cover is connected to the middle valve body through a bolt.

In an embodiment, a first sealing gasket is mounted between the middle valve body and the valve body, and a second sealing gasket is mounted between the lower valve cover and the valve body.

In an embodiment, the lower valve cover is connected to the valve body through a bolt.

In an embodiment, the driving cam is in contact with the baffle.

In an embodiment, an inner diameter of an upper part of the upper valve chamber is larger than that of a lower part of the upper valve chamber, and the spring is arranged in the upper part of the upper valve chamber.

In an embodiment, an outer wall of the valve core holder is provided with external threads, and an inner wall of the valve seat is provided with internal threads, and the valve seat is screwed onto an exterior of the valve core holder.

In an embodiment, the valve core is in interference fit with the cage sheath and is sleeved in the cage sheath, and the throttle hole of the valve core and the throttle hole of the cage sheath are coaxial.

In an embodiment, a side wall of the upper valve chamber is provided with a through hole, and a cable of the motor passes through the through hole.

With the above technical solutions, the present application has the following advantages.

1. The dual-channel cage-type subsea throttle valve according to the present application addresses the issue in the conventional technology that a valve core of a throttle valve is easily eroded and damaged by gravel in oil and gas. The throttle valve achieves throttling by arranging two valve cores in parallel in the same valve chamber. Compared with a single-chamber throttle valve, the dual-channel cage-type subsea throttle valve is provided with two channels in the valve body, which changes the flow field distribution and the particle movement trajectory of the original single-channel throttle valve, and can reduce the oil and gas velocity and decrease the collision speed of particles on a wall surface of the valve core when entering the throttle valve. Consequently, the amount of the oil and gas passing through the valve core per unit time is reduced, and the impact of high-speed fluid on the wall surface of the valve core is reduced, thereby reducing vibration and noise caused by the impact, improving the erosion resistance of the valve core, extending the erosion life of the throttle valve, and improving the service life of the throttle valve.

2. According to the dual-channel cage-type subsea throttle valve provided by the present application, the two valve cores are arranged in parallel, which increases the effective working area of the valve cores. The flow field distribution is changed through the multi-valve-core structure, which can increase the flow regulation capacity of the throttle valve. The two valve cores thereof can be opened or closed independently, which improves the throttling capability of the throttle valve, increases the flow rate of the throttle valve, and addresses the fundamental issue of valve core erosion caused by the transportation of large-flow sand-laden media by the subsea throttle valve.

### BRIEF DESCRIPTION OF THE DRAWINGS

FIG. 1 is a schematic structural diagram of a dual-channel cage-type subsea throttle valve according to a first embodiment of the present application.

FIG. 2 is a partial enlarged view of Part A in FIG. 1.

FIG. 3 is a schematic structural diagram of a valve core of the dual-channel cage-type subsea throttle valve according to the first embodiment of the present application.

FIG. 4 is a schematic structural diagram of a valve stem of the dual-channel cage-type subsea throttle valve according to the first embodiment of the present application.

FIG. 5 is a schematic structural diagram of a middle valve body of the dual-channel cage-type subsea throttle valve according to the first embodiment of the present application.

FIG. 6 is a schematic structural diagram of a valve body of the dual-channel cage-type subsea throttle valve according to the first embodiment of the present application.

FIG. 7 is a schematic structural diagram of a lower valve cover of the dual-channel cage-type subsea throttle valve according to the first embodiment of the present application.

Reference signs in the figures are listed as follows:

101 fluid inlet; 102 fluid outlet;

1 upper valve cover; 2 sealing gasket ring;

3 driving cam; 4 middle valve body;

401 upper valve chamber; 5 baffle;

6 first sealing gasket; 7 spring;

8 valve stem; 9 valve core;

901 throttling hole; 10 valve body;

11 cage sheath; 110 lower valve chamber;

12 second sealing gasket; 13 lower valve cover;

14 valve core holder; 15 valve seat;

16 sealing ring.

### DETAILED DESCRIPTION OF THE EMBODIMENTS

In order to make the purpose, technical solutions and advantages of the present application clearer, the technical solutions of the present application are clearly and completely described below with the attached drawings. Apparently, the described embodiments are part of the embodiments of the present application, not all of the embodiments. Based on the embodiments in the present application, all other embodiments obtained by those skilled in the art without creative labor fall within the protection scope of the present application.

In the description of the present application, it should be noted that, orientations or positional relationships indicated by the terms, such as "upper", "lower", "front" and "rear" are based on the orientations or position relationships shown in the drawings, and are only for the convenience of describing the present application and simplifying the description, and does not indicate or imply that systems or elements referred to must have a specific orientation, be constructed and operated in a specific orientation, and thus should not be understood as limitations to the present application. Directions indicated by arrows in the figures represent the directions of liquid circulation.

In the description of the present application, it should be noted that, unless otherwise specified and limited, the terms "assemble", "arrange" and "connect" should be broadly understood. For example, a connection may be a fixed connection, a detachable connection or integrated connection; it may be a mechanical connection or an electrical connection; it may be a direct connection, or an indirect connection through an intermediate medium, or may be an internal communication between two elements. For those skilled in the art, the specific meanings of the above terms in the present application may be understood based on specific situations.

A double-channel cage-type subsea throttle valve is provided according to the present application. By providing two channels in a valve body, the oil and gas speed can be reduced, and the impact of high-speed fluid on a wall surface of a valve core can be reduced, thereby reducing vibration and noise caused by the impact and improving the service life of the throttle valve.

The embodiments of the present application are described in detail below with reference to the drawings.

### Embodiments

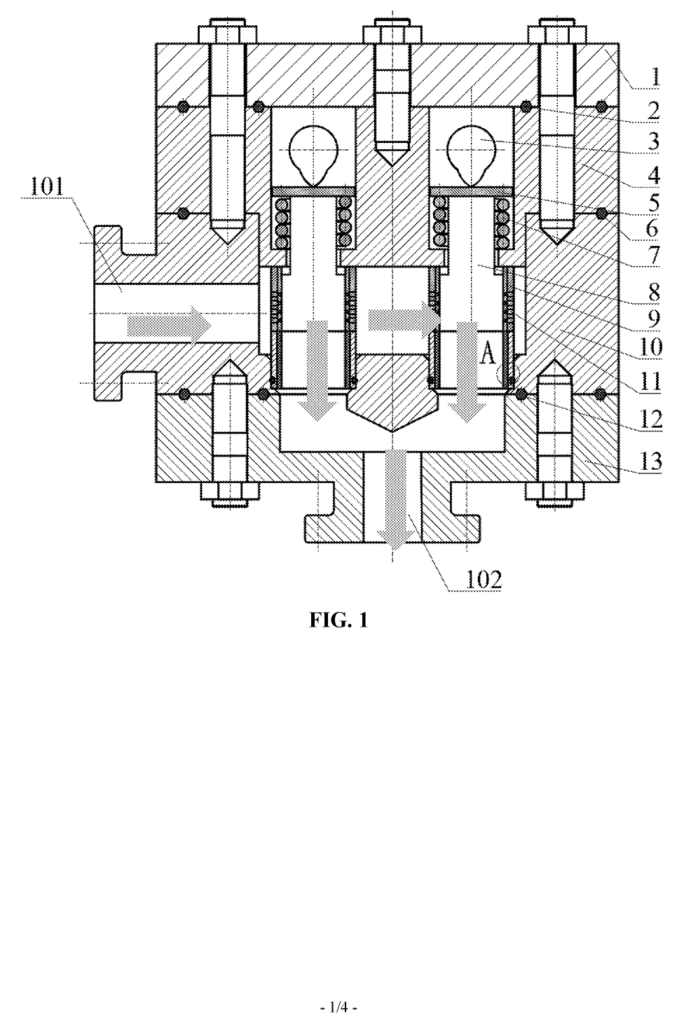

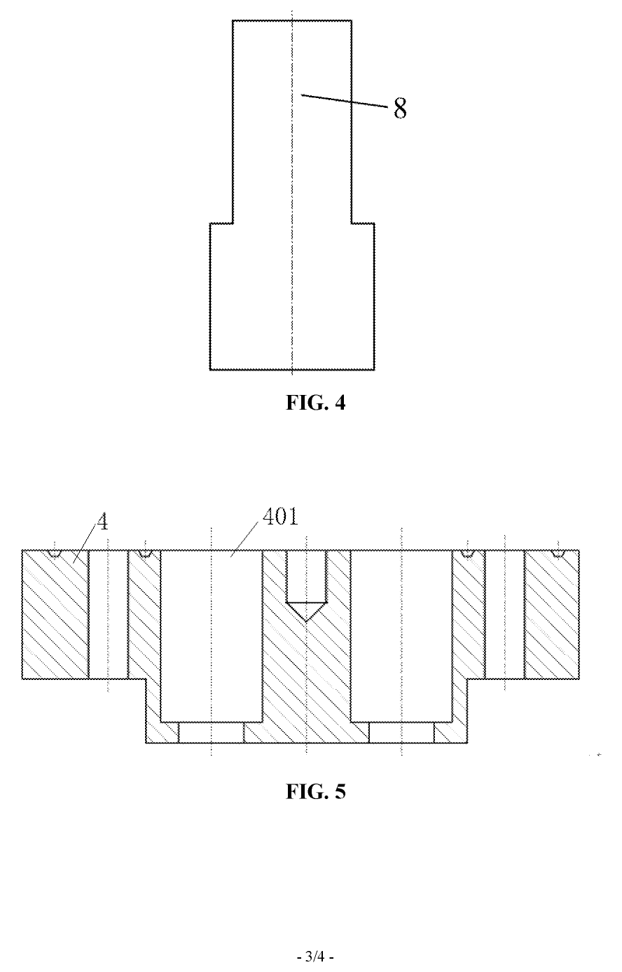

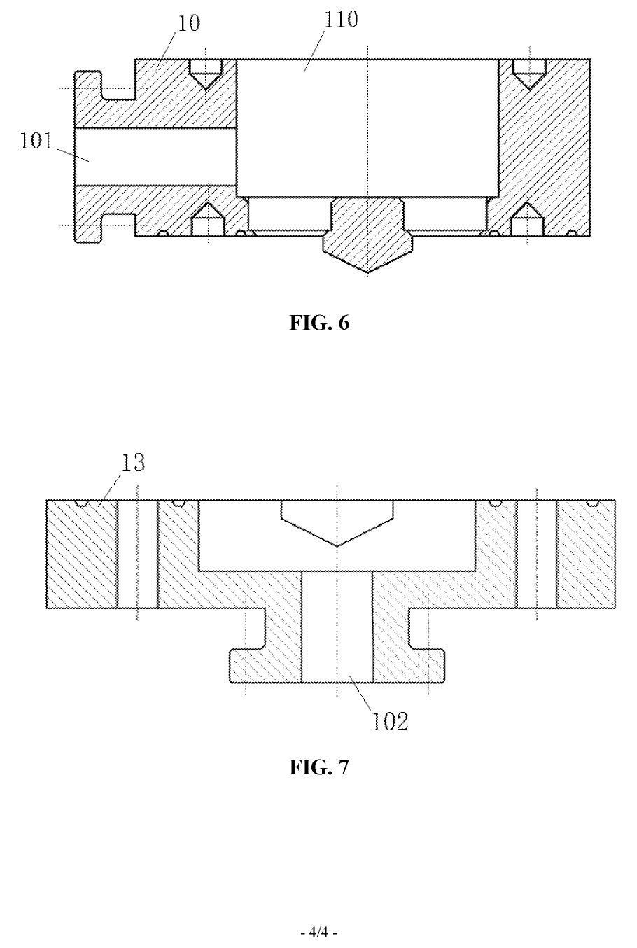

Referring to FIGS. 1 to 7, a dual-channel cage-type subsea throttle valve provided according to an embodiment of the present application includes an upper valve cover 1, a middle valve body 4, a valve body 10 and a lower valve cover 13. Two upper valve chambers 401 are provided in the middle valve body 4. The upper valve cover 1 is connected to a top of the middle valve body 4. The valve body 10 is connected to a bottom of the middle valve body 4. Lower valve chambers 110 are provided in the valve body 10. The two upper valve chambers 401 are respectively connected to the lower valve chambers 110. The valve body 10 is provided with a fluid inlet 101 connected to the lower valve chambers 110. The lower valve cover 13 is connected to a bottom of the valve body 10. The lower valve cover 13 is provided with a fluid outlet 102, and the two lower valve chambers 110 are connected to the fluid outlet 102.

A driving cam 3, a motor, a baffle 5 and a spring 7 are provided in each of the two upper valve chambers 401. The motor is connected to the driving cam 3. The baffle 5 is arranged below the driving cam 3. The spring 7 is arranged between the baffle 5 and a bottom surface of the upper valve chamber 401.

A valve stem 8, a valve core 9, a cage sheath 11, a valve core holder 14 and a valve seat 15 are provided in each of the two lower valve chambers 110. The valve stem 8 is slidably arranged in the lower valve chamber 110, and includes a top that extends into the upper valve chamber 401 and is sleeved in the spring 7. The top of the valve stem 8 is connected to the baffle 5. The valve core 9 is arranged in an upper part of the lower valve chamber 110 and sleeved outside the valve stem 8. The cage sheath 11 is sleeved outside the valve core 9. Each of a side wall of the valve core 9 and a side wall of the cage sheath 11 is provided with a throttling hole 901. The valve core holder 14 is arranged below the valve core 9 to fix and support the valve core 9. The valve seat 15 is arranged below the cage sheath 11 and sleeved outside the valve core holder 14.

According to the dual-channel cage-type subsea throttle valve provided by the embodiment, throttling is performed by the two valve cores 9 arranged side by side. Oil and gas enter from the fluid inlet 101 and flow out from the fluid outlet 102. The fluid inlet 101 may be formed in a left side wall of the valve body 10, and the fluid outlet 102 may be formed in a bottom surface of the lower valve cover 13. The two upper valve chambers 401 are vertically communicated with the two lower valve chambers 110 respectively, and the two upper valve chambers 401 and the two lower valve chambers 110 are communicated, so as to form a valve chamber. The motor may be a servo motor. During operation, the throttle valve drives the driving cam 3 to rotate through the motor, and the driving cam 3 contacts the baffle 5 and presses the baffle 5 downward, thereby moving the valve stem 8 downward to close the throttle hole 801. As the driving cam 3 continues to rotate, the spring 7 drives the valve stem 8 to move upward, and the throttle valve starts to operate. The two valve cores 9 of the throttle valve may be opened simultaneously or individually based on the flow rate, that is, the two valve cores 8 may operate independently or in conjunction.

The arrows in FIG. 1 indicate the direction of fluid flow. By arranging two channels in the valve body 10, the oil and gas velocity can be reduced, and the impact of high-speed fluid on the wall surface of the valve core 9 can be reduced, thereby reducing the vibration and noise caused by the impact and improving the service life of the throttle valve.

Referring to FIG. 1, in some embodiments, a sealing gasket ring 2 is mounted between the upper valve cover 1 and the middle valve body 4. The sealing gasket ring 2 may be an O-ring seal, and may be combined with the upper valve cover 1 and connected to the middle valve body 4 by tightening a bolt, so that the O-ring seal is deformed to isolate fluid inside and outside the valve chamber, thereby achieving reliable sealing.

In some embodiments, a first sealing gasket 6 is mounted between the middle valve body 4 and the valve body 10. A second sealing gasket 12 is mounted between the lower valve cover 13 and the valve body 10, and may be combined with the lower valve cover 13 and connected to the valve body 10 by a bolt, so that the O-ring seal is deformed to isolate the fluid inside and outside the valve chamber, thereby achieving reliable sealing.

In some embodiments, the driving cam 3 is in contact with the baffle 5.

Referring to FIG. 1 and FIG. 4 together, in some embodiments, an inner diameter of an upper part of the upper valve chamber 401 is larger than an inner diameter of a lower part of the upper valve chamber 401. The spring 7 is arranged in the upper part of the upper valve chamber 401. That is, a vertical cross-section of the upper valve chamber 401 may be designed as a T-shape.

In an embodiment, a vertical cross-section of the valve stem 8 is inverted T-shaped, that is, an outer diameter of an upper part of the valve stem 8 is smaller than that of a lower part of the valve stem 8. The upper part of the valve stem 8 is arranged in the upper valve chamber 401 and the lower part of the valve stem 8 is arranged in the lower valve chamber 110.

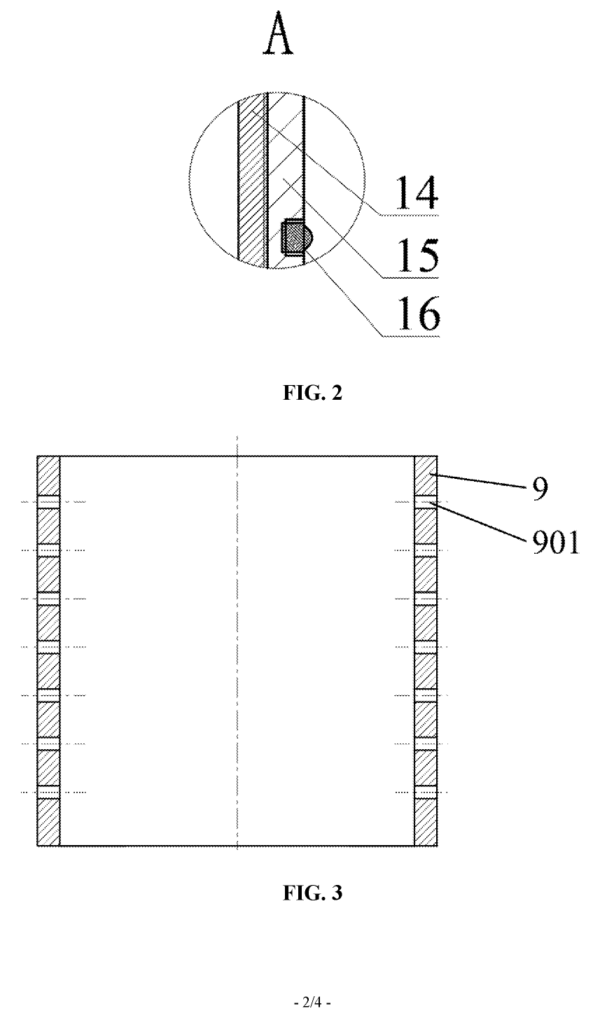

Referring to FIGS. 1 and 2, in some embodiments, an outer wall of the valve core holder 14 is provided with external threads, and an inner wall of the valve seat 15 is provided with internal threads, and the valve seat 15 is screwed onto an exterior of the valve core holder 14.

A sealing ring 16 is arranged between the valve seat 15 and the valve body 10.

Referring to FIG. 1 and FIG. 3 together, in some embodiments, the valve core 9 is in interference fit with the cage sheath 11 and is sleeved in the cage sheath 11, and the throttle hole 801 of the valve core 9 and the throttle hole 801 of the cage sheath 11 are coaxial.

In some embodiments, a through hole is provided in a side wall of the upper valve chamber 401, and a cable of the motor passes through the through hole.

Finally, it should be noted that, the above embodiments are only used to illustrate the technical solutions of the present application, but not to limit them. Although the present application has been described in detail with reference to the above embodiments, those skilled in the art should understand that modifications may still be made to the technical solutions described in the above embodiments, or equivalent substitutions may be made to some of the technical features; and these modifications or substitutions do not cause the essence of the corresponding technical solutions to deviate from the spirit and scope of the technical solutions of various embodiments of the present application.

1. A dual-channel cage-type subsea throttle valve, comprising:
an upper valve cover;
a middle valve body, wherein two upper valve chambers are defined in the middle valve body, and the upper valve cover is connected to a top of the middle valve body;
a valve body connected to a bottom of the middle valve body, wherein lower valve chambers are defined in the valve body, and the two upper valve chambers are respectively connected to the lower valve chambers, and the valve body is provided with a fluid inlet connected to the lower valve chambers; and
a lower valve cover connected to a bottom of the valve body, wherein the lower valve cover is provided with a fluid outlet, and the two lower valve chambers are connected to the fluid outlet; wherein
a driving cam, a motor, a baffle, and a spring are provided in each of the two upper valve chambers;
the motor is connected to the driving cam, the baffle is arranged below the driving cam, and the spring is arranged between the baffle and a bottom surface of the upper valve chamber;
a valve stem, a valve core, a cage sheath, a valve core holder, and a valve seat are provided in each of the two lower valve chambers;
the valve stem is slidably arranged in the lower valve chamber and has a top that extends into the upper valve chamber and is sleeved in the spring, and the top of the valve stem is connected to the baffle;
the valve core is arranged in an upper part of the lower valve chamber and sleeved outside the valve stem;
the cage sheath is sleeved outside the valve core, and a side wall of the valve core and a side wall of the cage sheath are provided with throttling holes;
the valve core holder is arranged below the valve core to fix and support the valve core; and
the valve seat is arranged below the cage sheath and sleeved outside the valve core holder.

2. The dual-channel cage-type subsea throttle valve according to claim 1, wherein a sealing gasket ring is mounted between the upper valve cover and the middle valve body.

3. The dual-channel cage-type subsea throttle valve according to claim 1, wherein the upper valve cover is connected to the middle valve body through a bolt.

4. The dual-channel cage-type subsea throttle valve according to claim 1, wherein a first sealing gasket is mounted between the middle valve body and the valve body, and a second sealing gasket is mounted between the lower valve cover and the valve body.

5. The dual-channel cage-type subsea throttle valve according to claim 1, wherein the lower valve cover is connected to the valve body through a bolt.

6. The dual-channel cage-type subsea throttle valve according to claim 1, wherein the driving cam is in contact with the baffle.

7. The dual-channel cage-type subsea throttle valve according to claim 1, wherein an inner diameter of an upper part of the upper valve chamber is larger than an inner diameter of a lower part of the upper valve chamber, and the spring is arranged in the upper part of the upper valve chamber.

8. The dual-channel cage-type subsea throttle valve according to claim 1, wherein an outer wall of the valve core holder is provided with external threads, an inner wall of the valve seat is provided with internal threads, and the valve seat is screwed onto an exterior of the valve core holder.

9. The dual-channel cage-type subsea throttle valve according to claim 1, wherein the valve core is in interference fit with the cage sheath and is sleeved in the cage sheath, and the throttle hole of the valve core and the throttle hole of the cage sheath are coaxial.

10. The dual-channel cage-type subsea throttle valve according to claim 1, wherein a side wall of the upper valve chamber is provided with a through hole, and a cable of the motor passes through the through hole.

11. The dual-channel cage-type subsea throttle valve according to claim 2, wherein a side wall of the upper valve chamber is provided with a through hole, and a cable of the motor passes through the through hole.

12. The dual-channel cage-type subsea throttle valve according to claim 3, wherein a side wall of the upper valve chamber is provided with a through hole, and a cable of the motor passes through the through hole.

13. The dual-channel cage-type subsea throttle valve according to claim 4, wherein a side wall of the upper valve chamber is provided with a through hole, and a cable of the motor passes through the through hole.

14. The dual-channel cage-type subsea throttle valve according to claim 5, wherein a side wall of the upper valve chamber is provided with a through hole, and a cable of the motor passes through the through hole.

15. The dual-channel cage-type subsea throttle valve according to claim 6, wherein a side wall of the upper valve chamber is provided with a through hole, and a cable of the motor passes through the through hole.

16. The dual-channel cage-type subsea throttle valve according to claim 7, wherein a side wall of the upper valve chamber is provided with a through hole, and a cable of the motor passes through the through hole.

17. The dual-channel cage-type subsea throttle valve according to claim 8, wherein a side wall of the upper valve chamber is provided with a through hole, and a cable of the motor passes through the through hole.

18. The dual-channel cage-type subsea throttle valve according to claim 9, wherein a side wall of the upper valve chamber is provided with a through hole, and a cable of the motor passes through the through hole.
